(19) United States
(12) Patent Application Publication
(10) Pub. No.: US 2018/0027950 A1
(43) Pub. Date: Feb. 1, 2018

(54) CUSTOMIZED COSMETIC SYSTEM

(71) Applicant: GraceMink, Inc., Bayside, NY (US)

(72) Inventor: Minkyung Grace CHOI, Bayside, NY (US)

(21) Appl. No.: 15/663,454

(22) Filed: Jul. 28, 2017

Related U.S. Application Data
(60) Provisional application No. 62/368,856, filed on Jul. 29, 2016.

(51) Int. Cl. A45D 44/00; B01F 15/02; A45D 34/04; B01F 13/10

(52) U.S. Cl. CPC A45D 44/005; B01F 13/1066; B01F 15/0237; A45D 34/04; B01F 2215/0031

(57) ABSTRACT

A customized cosmetic system is provided. The system includes a dock and at least one cartridge containing a cosmetic disposed on the dock. The at least one cartridge or dock contains a mechanism for dispensing a metered or measured dose of the cosmetic. In some embodiments, the mechanism for dispensing a metered or measured does of the cosmetic is automated and configured to be hands-free. In some embodiments, a user collects and mixes the cosmetic in a base cosmetic disposed in the at least one cartridge. In some embodiments, a user applies the cosmetic directly onto a collection container.

### CROSS REFERENCE TO RELATED APPLICATION

This application claims priority to U.S. Provisional Application No. 62/368,856, filed Jul. 29, 2016, which is hereby incorporated herein in its entirety by reference thereto.

### TECHNICAL FIELD

Embodiments of the present disclosure relate to a device and method for producing a cosmetic product in a customized manner at a low cost. In some embodiments, the cosmetic product can be created using a variety of different components including with the aid of a software application on a mobile device for example.

### BACKGROUND

Today a wide range of cosmetic products are available in the consumer market. However, it is not easy to find a product that perfectly fits with one's taste and interest. First, the tone (e.g., color, lightness, etc.) and texture (e.g., dry, smooth, etc.) of each person's skin vary significantly. The appearance of skin also varies seasonally. Second, each individual has their own taste. Because makeup products, foundation or eye shadow for example, are applied directly to the human body, users, most of whom are women, tend to notice subtle differences in color and texture, which makes it hard to find a completely suitable color. Based on the foregoing, cosmetics come in a vast number of different colors and styles.

Further, even if one finds what appears to be a perfect shade, it may not be perfect in use. Unlike clothing which you can try on before purchase, you often have to buy retail sized makeup products, unless a small portion, or a sample, is available for trial. However, cosmetic samples or free-application services over the counter are usually available only for expensive products that are sold in prestige outlets. As a result, it is not uncommon for users to throw away the cosmetic product after a single use. In addition, inexpensive cosmetic products sold in mass outlets do not provide exclusive looks and/or provide a wide variety of colors.

Additionally, after having discovered a desired cosmetic, then searching for the item in-store/online, having to travel to and from a store to purchase the item, and proceeding with the trial or returns process is cumbersome. Online shopping for color cosmetics is particularly cumbersome as one needs to try on the color to see if it is flattering and therefore returns are usually consequential. Also, most stores carry a limited amount of colors/shades due to shelf space, which increases the barriers to consumption. Remote store locations, busy schedules, and shipping times (for online orders) can increase the amount of time a consumer has to wait until they can consume the desired cosmetic product.

Additionally, many users desire to alter or add color to products in their current collection of cosmetic and skincare products. Adding pigments without prior formulating experience can be challenging and many users do not know how to mix colors (pigments/dyes) to get the exact desired effect. Furthermore, with trend-based cosmetics, many users desire only a small amount of product but are forced to buy full size products because smaller product volumes are not available. This creates waste because there is no control over how much (quantity) of a particular item a consumer can purchase. If a consumer wanted one swipe of particular lipstick color for a night out, the consumer would have to buy the smallest available retail unit size, typically a tube of lipstick, which leads to waste.

Based on the foregoing, a need exists for an easy, convenient, low cost way to instantly consume/recreate the physical products that we see online, in-app, and on social media; one that is easy to understand and allows for improvisation as well as full automation so that a user can customize his or her experience as well as the product. It will be appreciated that the user can also get input data from other sources other than online, app, or social media, which includes, for example, print magazines, word of mouth, television, etc. It will be appreciated that the teachings described herein are not limited to a personal consumer setting but instead can be implemented in, for example, a commercial, retail, or manufacturing setting.

### SUMMARY

Some embodiments are directed to a customized cosmetic system having a dock and at least one cartridge containing cosmetics disposed on the dock, each having a mechanism for dispensing a metered dose of cosmetic. The customized cosmetic system can include means disposed in the dock for dispensing the metered dose of cosmetics and a base cartridge for collecting and mixing the metered dose of cosmetics to create a customized cosmetic.

Some embodiments are directed to a customized cosmetic system having a dock and at least one cartridge containing cosmetics disposed on the dock. The customized cosmetic system can include means disposed in the dock or the cartridge for dispensing a metered or measured dose of cosmetics.

In some embodiments, a customized cosmetic system includes a dock, at least one cartridge containing a cosmetic disposed on the dock, and means disposed in the dock or in the at least one cartridge for dispensing a metered or measured dose of the cosmetic.

In some embodiments, the means to dispense a metered or measured dose of the cosmetic utilizes rotational motion. In some embodiments, the means to dispense a metered or measured dose of the cosmetic includes a circular or ring shaped metered scale. In some embodiments, the dock includes an area configured to couple securely to a cosmetic jar or a cosmetic compact. In some embodiments, the dock includes at least one opening through which the cosmetic is applied to a collection container. For example, the collection container includes a base, an intermediate surface, a mixing surface, or a collection compartment. In some embodiments, the at least one opening is configured to be a connection point to the at least one cartridge.

In some embodiments, the collection container is an intermediate surface. For example, the intermediate surface can include a container, a sponge, a finger, a swab, a brush, a sheet, or a pad. In some embodiments, the collection container is a base cosmetic. For example, the base cosmetic is selected from the group consisting of a solid, powder, cream, lotion, liquid, gel, emulsion, wax, oil, ester, and mixtures thereof. In some embodiments, the base cosmetic is a finished cosmetic retail item. In some embodiments, the base cosmetic is disposed in the at least one cartridge configured to collect and mix the cosmetic.

In some embodiments, the cosmetic includes at least one coloring agent. In some embodiments, the at least one coloring agent is a material selected from the group consisting of a natural dye, synthetic colorant, coal tar, chromium oxide, aluminum powder, manganese, iron oxide, mica flakes, cosmetic color additive, and mixtures thereof. In some embodiments, the cosmetic includes at least one additive. In some embodiments, the at least one additive is a material selected from the group consisting of a bulking agent, fragrance, preservative, pearlescent material, sparkle material, shimmer material, and combinations thereof.

In some embodiments, the at least one cartridge includes a gripping surface configured to be manually operated. In some embodiments, a metered dispensing mechanism is operatively coupled for automation. In some embodiments, the at least one cartridge includes a mechanism to controllably dispense or advance the cosmetic. In some embodiments, the mechanism to controllably dispense or advance the cosmetic includes a grinding insert, a rotating dial, a grinding cap, a hole, or any combinations thereof. In some embodiments, the mechanism to controllably dispense or advance the cosmetic includes a spring, rotating dial, plunger, slider, extruder, pump, valve, jet, grate, piston, reducer, mesh, grill, aperture, or any combinations thereof.

In some embodiments, a customized cosmetic system includes a computing device in communication with or disposed in the system. In some embodiments, the computing device is a mobile device configured to execute a software application. In some embodiments, the computing device is a virtual or augmented reality device configured to execute a software application.

In some embodiments, the dock is a cap. In some embodiments, the cap comprises a grinding insert, a rotating dial, a grinding cap, a hole, or any combinations thereof and is configured to controllably dispense or advance the cosmetic. In some embodiments, the cap comprises a grinder, a spring, a rotating dial, a plunger, a slider, an extruder, a pump, a valve, a jet, a grate, a piston, a reducer, a mesh, a grill, an aperture, or any combinations thereof and is configured to controllably dispense or advance the cosmetic.

In some embodiments, the automated metered dispensing mechanism is a motor, actuator, gear system, or combination thereof and configured to be hands-free.

In some embodiments, the collection container is a mixing surface or a collection compartment and includes a collection mechanism configured to mix or homogenize the cosmetic. In some embodiments, the collection mechanism to mix or homogenize the cosmetic is electrical, mechanical, magnetic, or any combinations thereof. In some embodiments, the collection mechanism to mix or homogenize the cosmetic is electrical, mechanical, magnetic, thermal, vibrational, rotational, or any combination thereof. In some embodiments, the dock, the at least one cartridge, the means to dispense a metered or measured dose of the cosmetic, the collection container, a liquid stick, or any combination thereof comprise a kit, wherein the kit is single-use or disposable.

### BRIEF DESCRIPTION OF THE DRAWINGS

FIG. 1 shows a customized cosmetic system according to an embodiment of the present invention.

FIG. 2 is an exploded view of a removable cartridge of the customized cosmetic system.

FIG. 3 shows a cross-sectional view taken along line 3-3 in FIG. 1.

FIG. 4 shows the customized cosmetic system in use.

FIG. 5 shows a liquid cosmetic stick, which can be used in the customized cosmetic system.

FIG. 6 shows a customized cosmetic system according to an embodiment of the present invention.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

References to “one embodiment,” “an embodiment,” “some embodiments,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The customized cosmetic system 1 of the present invention relates to an apparatus and collection container for producing a cosmetic composition in a customized manner at low cost. More specifically, the customized cosmetic system 1 relates to dispensing controllable metered amounts of a cosmetic substance through the utilization of a metered rotating dial 46 affixed to a cosmetic containing cartridge 40 which dispenses a cosmetic 21 or dispenses a cosmetic 21 through a metered dispensing mechanism 19 operatively coupled for automation. In some embodiments, for example, metered dispensing mechanism 19 can be coupled to rotating dial 46 and outer sidewall 50 of removable cartridge 40. For example, metered dispensing mechanism 19 can be a motor, an actuator, or gear system 20. In some embodiments, metered dispensing mechanism 19 is configured to be hands-free. More specifically, the customized cosmetic system 1 of the present invention uses a plurality of removable cartridges 40 coupled to a pigment collecting dock 10 that has an inner compartment 22 to collect and dispense pigments from cartridges 40. One means disposed in dock 10 for dispensing a metered or measured dose of cosmetics can be the inner compartment 22. In some embodiments, inner compartment 22 can include a rotating dial 46 or a grinding cap 80. Dock 10 features an exit hole 26 to allow the user to easily dispense the collected pigments onto a targeted area such as a base container 110. Alternatively, exit hole 26 can include a pull out tray for dispensing the cosmetics. Dock 10 can contain an opening that allows a cosmetic to be applied to a base, intermediate surface, mixing surface or collection compartment, the opening being a connection point to cartridge 40.

Dock 10 features a plurality of base dock openings 24 to securely receive removable cartridges 40. In some embodiments, cartridges 40 can each contain a cosmetic 21, for example, primary pigments, secondary pigments, and base materials, as well as a coloring agent including a material selected from the group consisting of a natural dye, synthetic colorant, coal tar, chromium oxide, aluminum powder, manganese, iron oxide, mica flakes, a cosmetic color additive, and mixtures thereof. In some embodiments, cartridges 40 can each contain a cosmetic 21 that further contains a bulking agent or an additive. An additive is a material that adds additional values to the cosmetic composition and can be, for example, fragrance, preservative, pearlescent, sparkle, glitter, shimmer, or combinations thereof. A bulking agent is used to provide even coverage on skin and usually has a smooth, slippery texture that makes the cosmetic composition easier to apply. The bulking agent can be, for example, mica, talc, silk powder, silk fiber, nylon, wax, cream, ester and oil, or mixtures thereof.

In one embodiment, a number of cartridges 40 can be used that contain pigments that are suitable for cosmetic applications. For example, cartridges 40 can contain the following pigments: cyan (C), magenta (M), yellow (Y), or combinations thereof. In some embodiments, each cartridge 40 holds one color. Alternatively, in some embodiments, one cartridge 40 contains more than one color with each pigment separated from the other. It will be appreciated that some applications can require more cartridges 40 and can include other color cartridges 40, for example, light magenta and light cyan. In some embodiments, dock 10 can contain more than three dock openings 24 to receive additional cartridges 40 including, for example, a base cartridge 70 containing a base cosmetic 102 as described herein. Further, as discussed herein, dock 10 can receive not only pigment cartridges for applying pigments onto a base cosmetic 102, but can also receive non-pigment cartridges 40.

Accurate doses of pigment are dispensed by turning rotating dial 46 on removable cartridge 40 until the prescribed number reaches metered marker 30 on dock 10. A gripping surface can be disposed on an outer sidewall 50 of cartridge 40 to enable easy gripping by the user for operating the system manually. Besides rotating dial 46, other means can be used to dispense a metered or measured dose through the utilization of rotation. Rotating dial 46 is initially set to starting point (“zero”) as indicted by metered marker 30 on dock 10. A ratchet, teeth rack, or other similar mechanism applies friction in one direction and enables active dispensing of pigment by turning rotating dial 46. The opposite, frictionless direction of the mechanism allows the user to set metered marker 30 to zero without activating dispensing of pigment. Alternatively, a latch, catch, or detent can be used to apply friction to cartridge 40 in dock opening 24 to maintain cartridge 40 in dock opening 24. Cartridge 40 can be selectively removed from dock opening 24 to allow for a user to set metered marker 30 to zero without activating dispensing of pigment. Alternatively, dock opening 24 can be sized to provide enough friction to secure and dispense pigment. Alternatively, there can be a friction surface between dock opening 24 and cartridge 40 to prevent relative movement between the two. A user can manually remove cartridge 40 from dock 10 and replace it when aligned properly to zero on metered marker 30 before each use. Prescribed numbers (“color codes”) can be obtained by the user through a software application or other means, for example, print, word of mouth, internet, or social media. An example of a software application for obtaining the prescribed numbers is described in U.S. Patent Application Publication No. 2015/0314141 to Choi, which is incorporated here in its entirety by reference thereto. The software application can be executed with a computing device that is a virtual or augmented reality device. Cartridges 40 of the present invention can be the type described in U.S. Pat. No. 8,387,627 to Yeom, which is incorporated here in its entirety by reference thereto.

In some embodiments, for example, automatic rotation of rotating dial 46 can include a motor, actuator, gear system, or combination thereof to generate linear, rotational, or oscillatory motion of rotating dial 46 for hands-free operation. In some embodiments, metered marker 30 can be located on rotating dial 46 and metered scale 48 can be located on removable cartridge 40. Alternatively, in some embodiments, metered marker 30 can be located on removable cartridge 40 and metered scale 48 can be located on rotating dial 46. In some embodiments, metered marker 30 can include a restickable, reusable, or repositionable mechanism including, for example, a sticker, magnet, insert, adhesive, or combination thereof. In some embodiments, metered scale 48 can be a ring, sleeve, band, annulus, etc., which rotates around removable cartridge 40.

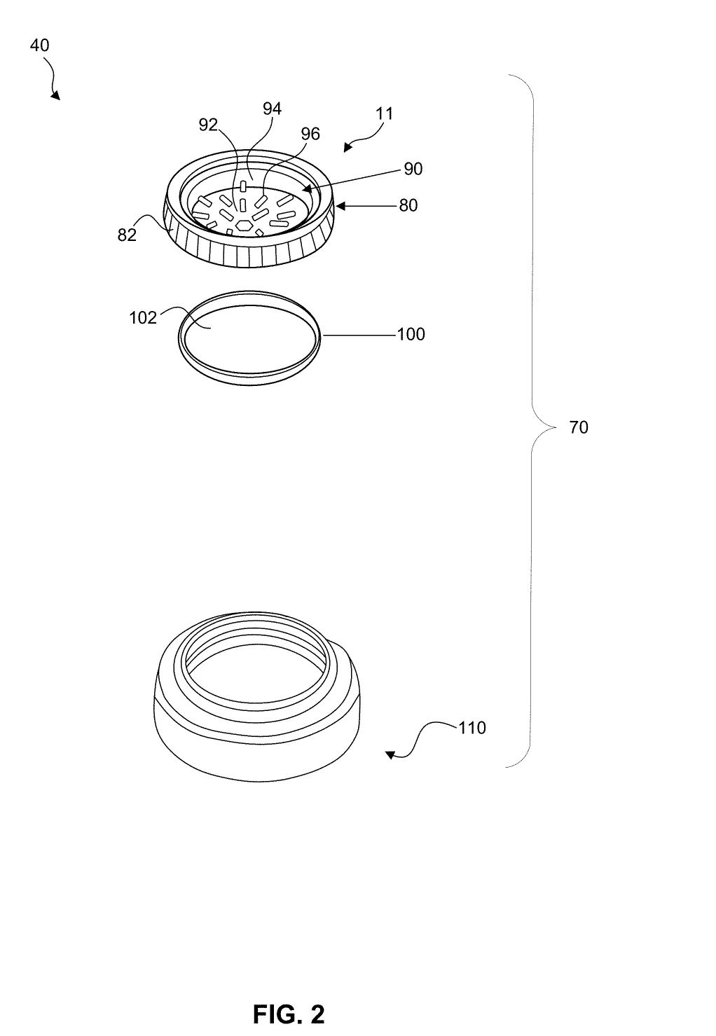

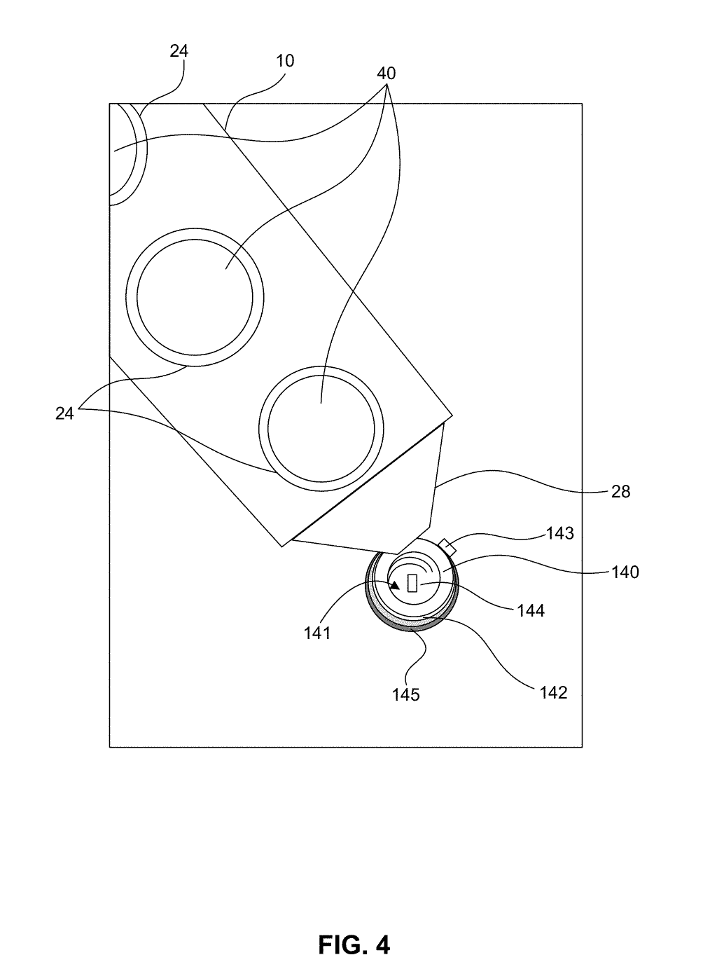

After dispensing the desired amount and combination of pigment from one or more removable cartridges 40, the dispensed pigments can exit through exit hole 26 or other exit means on dock 10. The dispensed pigment can be collected in a collection container shown generally at 140 in FIG. 4. In some embodiments, for example, the collection container 140 can be a base cartridge shown generally at 70. In some embodiments, the collection container 140 can be a base, an intermediate surface, a mixing surface, or a collection compartment. Base cartridge 70 includes base container shown generally at 110, cosmetic container 100, grinding insert 90, and grinding cap 80. Cosmetic container 100 includes a base cosmetic 102, which can be a colorable base material that can be, for example, a powder (mica, titanium dioxide, calcium carbonate, talc, etc.), oil, wax, ester, water, cream, lotion, liquid, gel, emulsion, a solid, or mixtures thereof. In some embodiments, removable cartridge 40 can be a base cartridge 70. For example, as shown in FIG. 2, removable cartridge 40 can include grinding cap 80, grinding insert 90, mixing surface 92 with holes 96, cosmetic container 100, base cosmetic 102, base container 110, or any combination thereof.

In some embodiments, grinding cap 80 can be an individual dock 11, which is coupled to, for example, a cosmetic jar or a cosmetic compact and dispenses a metered or measured dose of cosmetic by dispensing means. For example, dispensing means can include manual rotation of grinding cap 80 or automatic rotation of grinding cap 80 to dispense a metered or measured dose of cosmetic when rotated. In some embodiments, individual dock 11 can include grinding cap 80 and grinding insert 90. In some embodiments, individual dock 11 can include grinding cap 80, grinding insert 90, and cosmetic container 100 with base cosmetic 102. For example, individual dock 11 can couple to base container 110 such that either grinding cap 80 or base container 110 can be rotated, clockwise or counter-clockwise, to grate or scrape base cosmetic 102 into collection container 140, as shown in FIG. 4. In some embodiments, collection container 140 can be a base, an intermediate surface, a mixing surface, or a collection compartment. In some embodiments, for example, automatic rotation of grinding cap 80 can include a motor, actuator, gear system, or combination thereof to generate linear, rotational, or oscillatory motion of grinding cap 80 for hands-free operation. In some embodiments, metered marker 30 can be located on grinding cap 80 and metered scale 48 can be located on base container 110. Alternatively, in some embodiments, metered marker 30 can be located on base container 110 and metered scale 48 can be located on grinding cap 80. In some embodiments, metered marker 30 can include a restickable, reusable, or repositionable mechanism including, for example, a sticker, magnet, insert, adhesive, or combination thereof. In some embodiments, metered scale 48 can be a ring, sleeve, band, annulus, etc., which rotates around base cartridge 70.

Grinding cap 80 has a gripping surface 82 around its outer periphery to enable easy gripping by the user for operating the system manually. Grinding insert 90 has a grinding insert mixing surface 92 with holes 96, which when rotated, grate or scrape the packed pigment 102 in cosmetic container 100 releasing particles for creating customized cosmetics. As shown in FIG. 2, for example, base container 110 can be rotated to engage grinding insert 90 to grate or scrap the packed pigment 102 in cosmetic container 100 to release particles. In some embodiments, base container 110 is coupled to grinding cap 80, grinding insert 90, and cosmetic container 100 with base cosmetic 102, such that a user can rotate base container 110 or grinding cap 80 to grate or scrape base cosmetic 102 into base container 110. For example, base container 110 can contain a spring or constant force mechanism to push or maintain constant pressure on cosmetic container 100 toward grinding insert 90 when either base container 110 or grinding cap 80 is rotated. Rotation of grinding insert mixing surface 92 or base container 110 can be done manually or can be automated such as with a motor or other similar device. Grinding insert mixing surface 92 can act as a mixing palette. Base container 110 can also act as a cosmetic storage case with the aid of a cap. This allows base container 110 to have multiple uses, which gives the user additional convenience. Grinding insert inner sidewall 94 of grinding insert 90 of cartridge 40 can be high, low, or flat depending on the base material contained therein. A higher wall or deeper well can be used for mixing powder. However, a shallower grinding insert inner sidewall 94, making grinding insert 90 almost flat, can be used for sticky bases like lip gloss, for easier cleaning purposes. For powder bases, it is helpful when grinding insert mixing surface 92 of cartridge 40 is uneven or texturized, such as a grill or a silicone finish.

In some embodiments, individual dock 11 can include a mechanism to controllably dispense or advance a cosmetic, for example, grinding insert 90. For example, the mechanism to controllably dispense or advance the cosmetic can include a spring, rotating dial, plunger, slider, extruder, pump, valve, jet, grate, piston, reducer, mesh, grill, aperture, or any combinations thereof. In some embodiments, grinding cap 80 includes a spring, rotating dial, plunger, slider, extruder, pump, valve, jet, grate, piston, reducer, mesh, grill, aperture, or any combinations thereof.

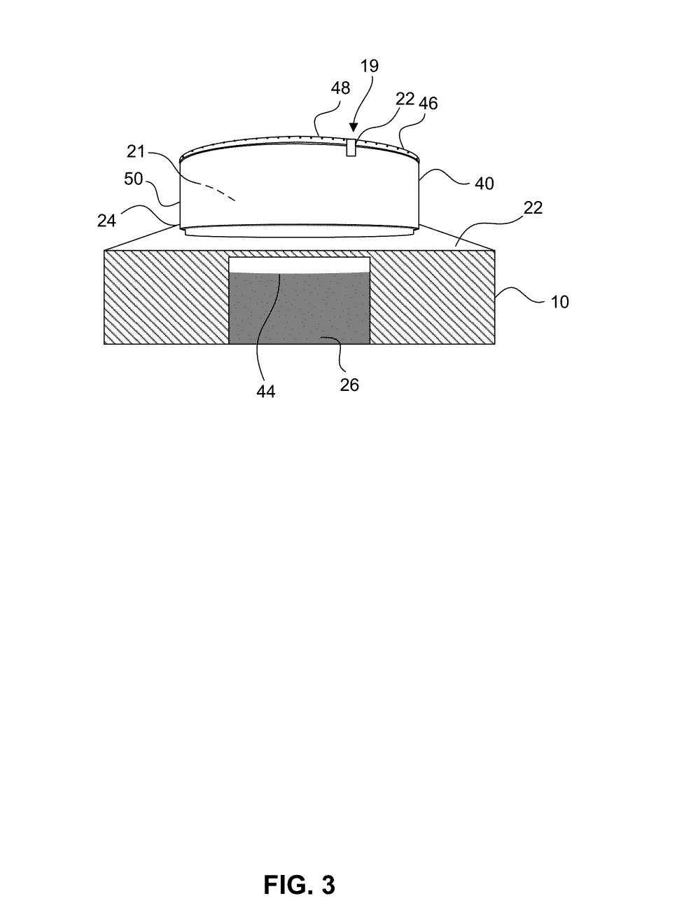

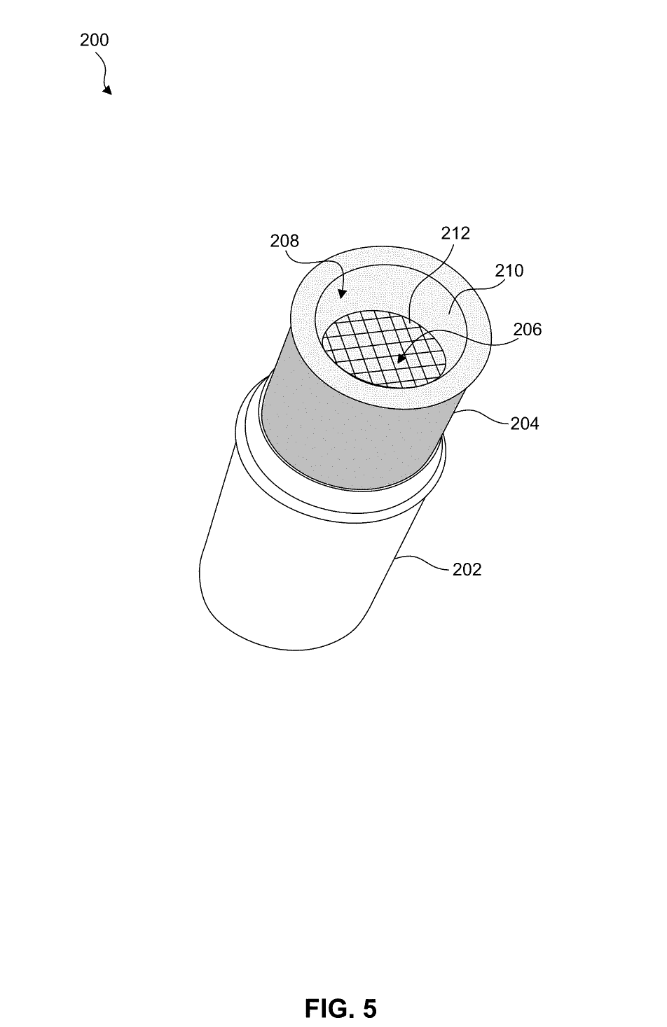

In use, a user first determines a color to create with customized cosmetic system 1. Prescribed numbers are then obtained, using the method previously described, in order to determine how much to turn rotating dial 46 so a metered scale 48 of cartridge 40 is appropriately aligned with metered marker 30 on dock 10. Alternatively, metered scale 48 can be located on dock 10 and metered marker 30 on cartridge 40. Metered scale 48 provides means to dispense a metered or measured dose through the use of a circular or ring shaped metered scale. Once the turning of rotating dials 46 is completed, the pigments from cartridges 40 will be in the inner compartment 22 of dock 10. The pigments from each cartridge 40 can be collected by pouring the pigments out of exit hole 26 of dock 10. FIG. 3 shows bottom 44 of removable cartridge 40 where the pigment will exit when rotating dial 46 is turned to grind the pigment. FIG. 3 also shows exit hole 26 where the collected pigment will leave dock 10. FIG. 4 shows the collection process of the pigment from cartridges 40 into a collection container 140. In some embodiments, collection container 140 can be another cartridge 40, base cartridge 70, or base container 110, or can be another device such as the liquid stick 200 in FIG. 5 or can be an intermediary surface such as a finger, a sponge, a swab, a sheet, a tissue, a brush, a plate, or a container. If a user decides to have collection container 140 be another cartridge 40, base cosmetic 102 in cosmetic container 100 can be either released before or after the collected pigment from dock 10 is added to collection container 140. A funnel 28 can be attached to dock 10 in order to ensure collected pigments can be collected in an efficient manner, minimizing spills and pigment loss. A valve or other mechanism can be added to funnel 28 or exit hole 26 to prevent backflow and contamination through exit hole 26 into dock 10. In some embodiments, collection container 140 can include a collection mechanism 141 configured to mix or homogenize the cosmetic 21 from exit hole 26 or funnel 28. In some embodiments, collection mechanism 141 is electrical, mechanical, magnetic, or any combination thereof. In some embodiments, for example, collection mechanism 141 can be an electrical wire 142 configured to resistively heat cosmetic 21 to a set temperature. In some embodiments, for example, collection mechanism 141 can be a mechanical motor 143 configured to translate, vibrate, agitate, or rotate cosmetic 21 to a designed homogeneity. In some embodiments, for example, collection mechanism 141 can be a magnetic stirrer 144 and magnetic rotational plate 145 configured to stir cosmetic 21 at a desired rate and time.

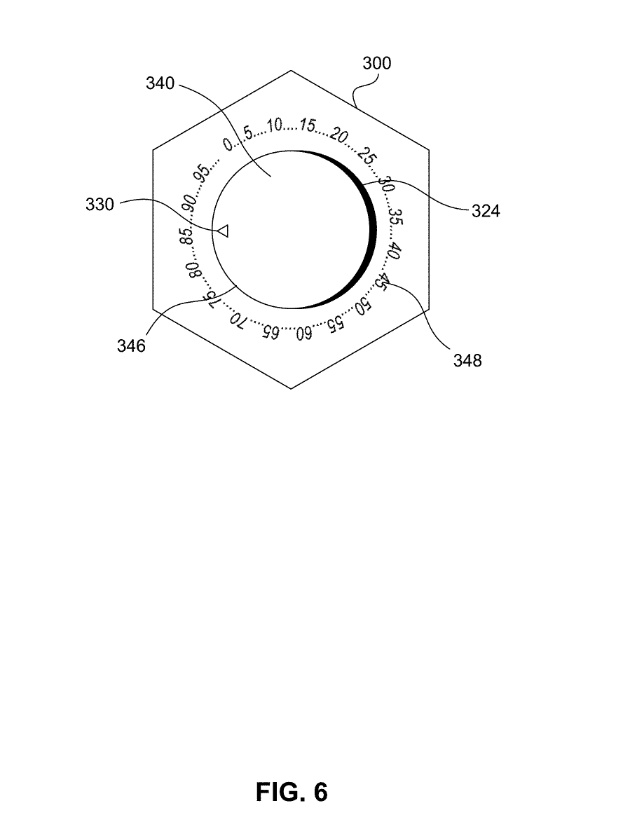

According to another embodiment, as shown in FIG. 6, dock 300 features one dock opening through-hole 324 to securely receive removable cartridge 340 and has no collection compartment so that the dispensed pigment will be applied directly to the base cosmetic, mixing surface or intermediary surface. Metered scale 348 is located on dock 300, and metered marker 330 is located on cartridge 340. Alternatively, metered scale 348 can be located on cartridge 340 and metered marker 330 on dock 300. When a user wants to set metered marker 330 back to zero, a user can manually uncouple cartridge 340 from dock 300 and then recouple cartridge 340, aligning it to metered marker 330. A user can use one or a plurality of cartridges 340 with dock 300 to create a customized cosmetic. Dock 300 features a flat surface area on its underside that accommodates and enables it to sit securely atop most color cosmetic jars and compacts so that the user can easily grind pigment directly onto a desired target when using the device. It will be appreciated that this feature is not limited to a flat surface shape but any means to rest or securely fit onto most color cosmetic jars and compacts. The description of dock 300 and cartridge 340, as described herein, is non-limiting. The features and description of dock 10 and cartridge 40, as described herein, can apply to dock 300 and cartridge 340 as well.

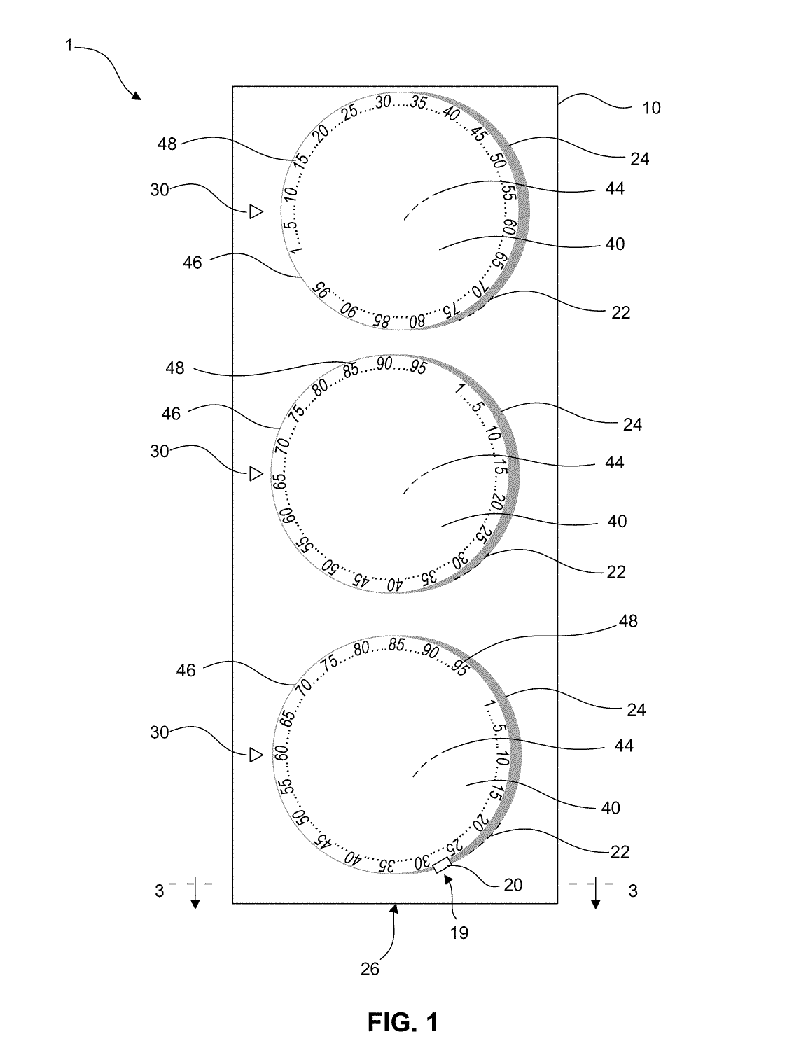

In some embodiments, a user can omit dock 10 or dock 300, and create a customized cosmetic with only cartridges 40. Cartridges 40 from FIG. 1 can be used individually without dock 10 or dock 300. In that case, rotating dial 46 and metered scale 48 will be facing downwardly in order to collect the pigment in cartridge 40. Alternatively, in some embodiments, rotating dial 46 and metered scale 48 can be located on bottom 44 or outer sidewall 50 of cartridge 40 or on gripping surface 82 of base cartridge 70 so that a user can more easily read rotating dial 46. After each rotating dial 46 is turned to produce pigment, the collected pigments from each cartridge 40 can be transferred to base cartridge 70 with base cosmetic 102 in cosmetic container 100 as a base material. By turning gripping cap 80, base cosmetic 102 will be scraped through holes 96 and rest on grinding insert mixing surface 92. The pigments poured onto grinding insert mixing surface 92 can then be mixed with cosmetic 102 to create a customized cosmetic. Other mechanisms can be used to dispense base cosmetic 102 into dock 10, for example, a spring, plunger, slider, extruder, valve, jet, grate, reducer, mesh, grinder, screw piston, airless or dip tube pump, or any combinations thereof.

In some embodiments, base cosmetic 102 can be an ester, for example, isopropyl lanolate, myristyl lactate, or octyl hydroxystearate. Base cosmetic 102 can be broadly thought of as a cosmetic base or foundation that is suitable for application to human skin for a cosmetic purpose. It will therefore be appreciated that customized cosmetic system 1 is configured to allow base cosmetic 102 to be colored according to a color selected by the user and/or be otherwise customized by the user (e.g., application of fragrance, etc.). Customized cosmetic system 1 thus serves to augment, color or otherwise apply a preselected color to the surface of base cosmetic 102 and since base cosmetic 102 is colorable or otherwise can assume the color of the applied colorant (pigments, inks, etc.), customized cosmetic system 1 causes base cosmetic 102 to change color from the base/starting color (white, light brown, cream, etc.) to the color selected by the user.

Base cosmetic 102 can also be a finished cosmetic retail item that a user possesses and wishes to augment. Base cosmetic 102 need not be inside base cartridge 70 but instead can be used in the original packaging of the finished cosmetic retail item. A user can dispense pigments directly onto base cosmetic 102, which can be a finished cosmetic retail item, then mix with a brush until the desired color is developed.

It will be appreciated that base cosmetic 102 has a thickness, and there is a relationship between the thickness of base cosmetic 102 and the amount of pigment or other material that is deposited onto base cosmetic 102 in order to ensure that the desired amount of material is colored and assumes the color selected by the user. In other words, the pigments are applied to base cosmetic 102 at an amount that allows for the pigment to be uniformly dispersed throughout the desired amount of base cosmetic 102. Thus, the total amount of pigment deposited from all of the cartridges 40 is preferably sufficient to color the desired amount of the base cosmetic 102. Base cosmetic 102 can contain a coloring agent including a material selected from the group consisting of a natural dye, synthetic colorant, coal tar, chromium oxide, aluminum powder, manganese, iron oxide, mica flakes, a cosmetic color additive, and mixtures thereof.

The thickness of base cosmetic 102 can also vary depending upon the cosmetic product being formed and more particularly, whether the final cosmetic product is a powder type makeup (e.g., eye shadow, blush, finishing powder, etc.) or a cream/fat/lotion/oil/wax/varnish based makeup (e.g., lipstick, foundation, lip gloss, cream eye shadow, nail polish, etc.).

FIG. 5 shows liquid stick 200 as another embodiment of collection container 140 or cartridge 40. Liquid stick 200 of the present invention can use an advancement mechanism as described in U.S. Pat. No. 5,573,341 to Iaia, which is incorporated herein in its entirety by reference thereto. Liquid stick 200 can contain a cosmetic, for example, a cream, wax, or liquid, which is produced from liquid stick 200 by turning liquid stick housing 202 relative to liquid stick container 204. The cosmetic is produced through apertures 212 to rest on a liquid stick mixing surface 206. Apertures 212 allow mixing without heat by instantly separating the cosmetic into small enough pieces that it is easily mixable with pigments from dock 10.

Well wall 210 creates a well 208 in liquid stick 200. The height of well wall 210 can be varied. Similar to grinding insert inner sidewall 94, well wall 210 can be high, low, or flat depending on the cosmetic contained therein. A high well wall 210 can help ensure the pigment is collected when poured into liquid stick 200. Apertures 212 provide an uneven or texturized liquid stick mixing surface 206, which can provide mixing benefits.

Liquid stick 200 can also be used as a cartridge 40 or 340 with liquid stick container 204 being disposed in dock opening 24 or through-hole 324. When liquid stick housing 202 is rotated on dock 10 or 300, the cosmetic is produced through apertures 212 and falls through dock opening 24 or through-hole 324 into the collection compartment, intermediate surface, base material or mixing surface.

In addition, a bristle brush can mix the cosmetic with the added pigment. A course, thick hair, synthetic brush is preferred over a thin hair, brush to mix the cosmetic and pigments. Product migration onto the brush greatly increases with thinner hair brushes, which can hinder mixing.

All of the foregoing embodiments can be used together in a kit. Dock 10, dock 300, removable cartridge 40, base cartridge 70, and liquid stick 200 can comprise a kit. There can be any number of combinations for the items in each kit. An individual kit can comprise none or several of each item. The exact combination and number of each item in the kit can be determined by user preferences. The kit enables users to create a customized cosmetic system. The kit can be single-use or disposable. Furthermore, the kit can be manually operated or automated. Users can create specific cosmetics by using the kit with a software application or a variety of other sources including online, social media, print magazines, word of mouth, or television.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A customized cosmetic system comprising:
a dock;
at least one cartridge containing a cosmetic disposed on the dock; and
a means disposed in the dock or in the at least one cartridge for dispensing a metered or measured dose of the cosmetic.

2. The system of claim 1, wherein the means to dispense a metered or measured dose of the cosmetic utilizes rotational motion.

3. The system of claim 1, wherein the means to dispense a metered or measured dose of the cosmetic includes a circular or ring shaped metered scale.

4. The system of claim 1, wherein the dock comprises an area configured to couple securely to a cosmetic jar or a cosmetic compact.

5. The system of claim 1, wherein the dock comprises at least one opening through which the cosmetic is applied to a collection container, the at least one opening configured to couple to the at least one cartridge.

6. The system of claim 5, wherein the collection container is an intermediate surface comprising a container, a sponge, a finger, a swab, a brush, a sheet, or a pad.

7. The system of claim 5, wherein the collection container is a base cosmetic selected from the group consisting of a solid, a powder, a cream, a lotion, a liquid, a gel, an emulsion, a wax, an oil, an ester, and mixtures thereof.

8. The system of claim 5, wherein the base cosmetic is a finished cosmetic retail item.

9. The system of claim 7, wherein the base cosmetic is disposed in the at least one cartridge configured to collect and mix the cosmetic.

10. The system of claim 1, wherein the cosmetic comprises at least one coloring agent.

11. The system of claim 10, wherein the at least one coloring agent is a material selected from the group consisting of a natural dye, synthetic colorant, coal tar, chromium oxide, aluminum powder, manganese, iron oxide, mica flakes, cosmetic color additive, and mixtures thereof.

12. The system of claim 1, wherein the cosmetic comprises at least one additive.

13. The system of claim 12, wherein the at least one additive is a material selected from the group consisting of a bulking agent, a fragrance, a preservative, a pearlescent material, a sparkle material, a shimmer material, and combinations thereof.

14. The system of claim 1, wherein the at least one cartridge comprises a gripping surface configured to be manually operated.

15. The system of claim 1, wherein a metered dispensing mechanism is operatively coupled for automation.

16. The system of claim 1, wherein the at least one cartridge comprises a mechanism to controllably dispense or advance the cosmetic.

17. The system of claim 16, wherein the mechanism to controllably dispense or advance the cosmetic comprises a grinding insert, a rotating dial, a grinding cap, a hole, or any combinations thereof.

18. The system of claim 1, wherein the dock is a cap, wherein the cap comprises a grinding insert, a rotating dial, a grinding cap, a hole, or any combinations thereof and is configured to controllably dispense or advance the cosmetic.

19. The system of claim 15, wherein the automated metered dispensing mechanism is a motor, actuator, gear system, or combination thereof and configured to be hands-free.

20. The system of claim 5, wherein the collection container is a mixing surface or a collection compartment and comprises a collection mechanism configured to mix or homogenize the cosmetic.

21. The system of claim 20, wherein the collection mechanism to mix or homogenize the cosmetic is electrical, mechanical, magnetic, or any combination thereof.

22. The system of claim 5, wherein the dock, the at least one cartridge, the means to dispense a metered or measured dose of the cosmetic, the collection container, a liquid stick, or any combination thereof comprise a kit, wherein the kit is single-use or disposable.
